(19) United States
(12) Patent Application Publication
(10) Pub. No.: US 2008/0022666 A1
(43) Pub. Date: Jan. 31, 2008

(54) Balanced partial two-stroke engine

(76) Inventors: James J. Driscoll, Dunlap, IL (US); Wade J. Robel, Peoria, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/496,258

(22) Filed: Jul. 31, 2006

(51) Int. Cl. F02M 25/06; F01N 5/04; F01N 3/00; F01N 3/10

(52) U.S. Cl. 60/286; 60/285; 60/280; 60/295; 60/301; 60/279

(57) ABSTRACT

An engine is provided. The engine may comprise a first cylinder group including at least one cylinder configured to operate in a two-stroke engine operating mode and a second cylinder group including at least two cylinders configured to operate in a four-stroke engine operating mode. The power outputs of each of the cylinders in the first cylinder group and second cylinder group may be approximately equal.

### TECHNICAL FIELD

This disclosure pertains generally to exhaust-gas purification systems for engines, and more particularly, to selective catalytic reduction systems with on-board ammonia production.

### BACKGROUND

Selective catalytic reduction (SCR) provides a method for removing nitrogen oxides (NOx) emissions from fossil fuel powered systems for engines, factories, and power plants. During SCR, a catalyst facilitates a reaction between exhaust-gas ammonia and NOx to produce water and nitrogen gas, thereby removing NOx from the exhaust gas.

The ammonia that is used for the SCR system may be produced during the operation of the NOx-producing system or may be stored for injection when needed. Because of the high reactivity of ammonia, storage of ammonia can be hazardous. Further, on-board production of ammonia can be costly and may require specialized equipment.

One method of on-board ammonia production for an engine is disclosed in U.S. Pat. No. 6,047,542, issued to Kinugasa on Apr. 11, 2000 (hereinafter the '542 patent). The method includes the use of multiple cylinder groups for purifying exhaust gas. In the method of the '542 patent, the exhaust gas of one cylinder group may be made rich by controlling the amount of fuel injected into the cylinder group. The rich exhaust gas of this cylinder group may then be passed over an ammonia-synthesizing catalyst to convert a portion of the NOx in the exhaust gas into ammonia. The exhaust gas and ammonia of the first cylinder group are then combined with the exhaust gas of a second cylinder group and passed through an SCR catalyst where the ammonia reacts with NOx to produce nitrogen gas and water.

While the method of the '542 patent may reduce NOx from an exhaust stream through use of on-board ammonia production, the method of the '542 patent has several drawbacks. For example, an engine may function less efficiently and with lower power output when rich combustion occurs in one cylinder group. Furthermore, using the method of the '542 patent, it may be more difficult to provide adequate and controlled air intake to both cylinder groups, and the two cylinder groups, operating as described in the '542 patent, may cause significant engine vibration.

The present disclosure is directed at overcoming one or more of the problems or disadvantages in the prior art.

### SUMMARY OF THE INVENTION

A first aspect of the present disclosure includes an engine. The engine may comprise a first cylinder group including at least one cylinder configured to operate in a two-stroke engine operating mode and a second cylinder group including at least two cylinders configured to operate in a four-stroke engine operating mode. The power outputs of each of the cylinders in the first cylinder group and second cylinder group may be approximately equal.

A second aspect of the present disclosure includes a method of operating an engine. The method may include operating a first cylinder group including at least one cylinder in a two-stroke engine operating mode, and operating a second cylinder group including at least two cylinders in a four-stroke engine operating mode. The power outputs of each of the cylinders in the first cylinder group and second cylinder group may be approximately equal.

A third aspect of the present disclosure includes an engine and exhaust system. The engine and exhaust system may include a first cylinder group including at least one cylinder configured to operate in a two-stroke engine operating mode and a second cylinder group including at least two cylinders configured to operate in a four-stroke engine operating mode, wherein the power outputs of each of the cylinders in the first cylinder group and second cylinder group are approximately equal. A first exhaust passage may be configured to receive a NOx-containing exhaust gas stream produced by at least one cylinder of the first cylinder group, and an ammonia-producing catalyst may be in fluid communication with the first exhaust passage and configured to convert at least a portion of the NOx-containing exhaust gas stream produced by the at least one cylinder of the first cylinder group into ammonia. A second exhaust passage may be configured to receive a NOx-containing exhaust gas stream produced by the second cylinder group, and a merged exhaust passage may be configured to receive exhaust from the first exhaust passage and second exhaust passage. A NOx-reducing catalyst may be in fluid communication with the merged exhaust passage and configured to facilitate a reaction between ammonia and NOx.

### BRIEF DESCRIPTION OF THE DRAWINGS

The accompanying drawings, which are incorporated in and constitute a part of this specification, illustrate exemplary embodiments of the disclosure and, together with the written description, serve to explain the principles of the disclosed system. In the drawings:

FIG. 1 illustrates a machine including an engine and exhaust system of the present disclosure.

FIG. 2. provides a diagram of an engine and exhaust system of the present disclosure, according to an exemplary embodiment.

FIG. 3. provides a diagram of an engine and exhaust system of the present disclosure, according to another exemplary embodiment.

### DETAILED DESCRIPTION

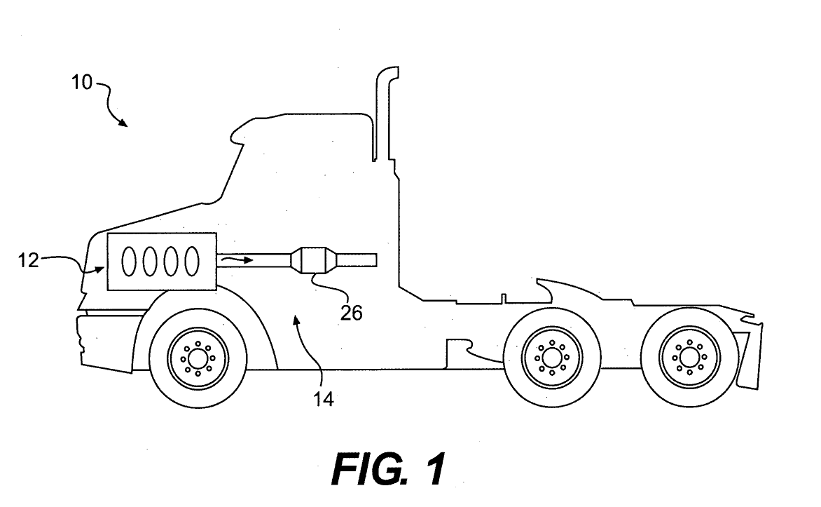

FIG. 1 illustrates a machine 10 including an engine 12 and exhaust system 14 of the present disclosure. As shown, exhaust system 14 may include one or more exhaust emissions control devices, such as a selective catalytic reduction (SCR) catalyst 26, which may be configured to control machine NOx emissions by facilitating a reaction between ammonia and NOx to remove NOx from exhaust gases produced by engine 12. Further, as described in detail below machine 10 may include systems and methods for on-board production of ammonia.

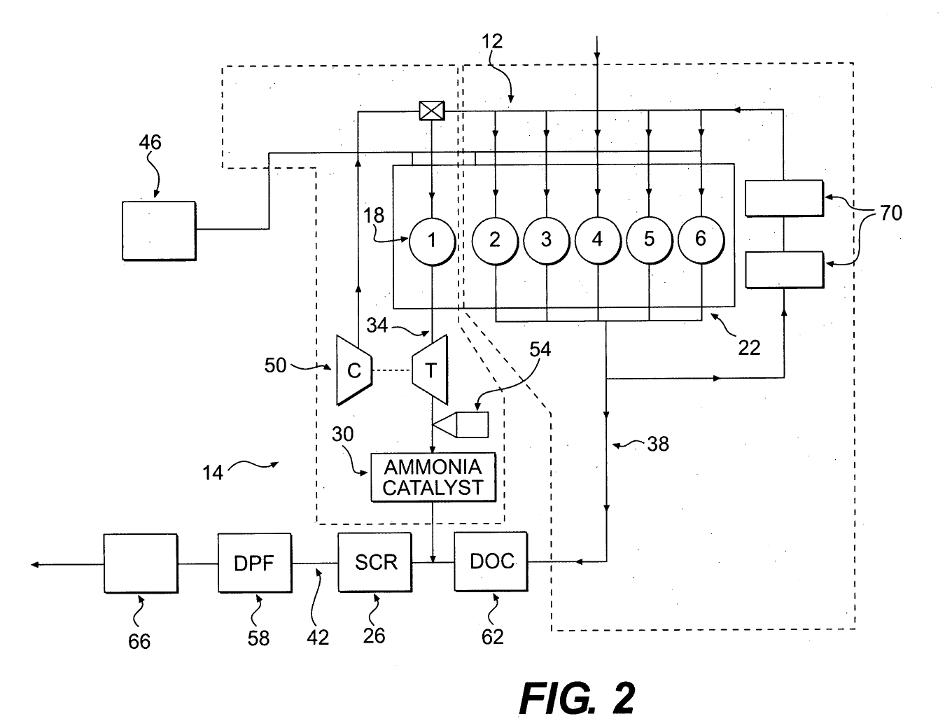

FIG. 2. provides a diagram of an engine 12 and exhaust system 14 of the present disclosure, according to an exemplary embodiment. As shown, engine 12 includes six cylinders (labeled 1-6) that are configured for combustion to produce power for machine 10. In some embodiments, engine 12 may include at least two cylinder groups 18, 22, wherein a first cylinder group 18 may include at least one cylinder 1, and a second cylinder group 22 may include two or more cylinders 2-6.

In some embodiments, the cylinders of first cylinder group 18 may be configured to operate as two-stroke cylinders, and the cylinders of second cylinder group 22 may be configured to operate as four-stroke cylinders. Further, at least one cylinder 1 from first cylinder group 18 may be disposed upstream of a catalyst 30 configured to produce ammonia from components of an exhaust gas produced by cylinder 1. In addition, to minimize engine vibration, in some embodiments, each of the cylinders of first and second cylinder groups (cylinders 1-6) may be configured to produce approximately equal power outputs.

The cylinders of first cylinder group 18 and/or second cylinder group 22 may include a variety of suitable engine cylinder types. For example, suitable engine types may include diesel engine cylinders, natural gas cylinders, or gasoline cylinders. The specific cylinder type may be selected based on the specific application, desired power output, available fuel infrastructure, and/or any other suitable factor. For example, natural gas engines may be selected for some engine types, such as generator sets. Diesel engines may be selected for on-highway trucks. However, as the available fuel infrastructure, fuel costs, and emission standards change, different engine types may be selected for any application.

As noted, at least one cylinder 1 from first cylinder group 18 may be disposed upstream of catalyst 30, which may be configured to produce ammonia from components of an exhaust gas produced by cylinder 1. The ammonia may be produced by a reaction between NOx and other substances in the exhaust-gas stream from first cylinder group 18. For example, NOx may react with a variety of other combustion byproducts to produce ammonia. These other combustion byproducts may include, for example, H₂ (hydrogen gas), C₃H₆ (propene), or CO (carbon monoxide).

Ammonia-producing catalyst 30 may be made from a variety of materials. In one embodiment, ammonia-producing catalyst 30 may include at least one of platinum, palladium, rhodium, iridium, copper, chrome, vanadium, titanium, iron, or cesium. Combinations of these materials may be used, and the catalyst material may be chosen based on the type of fuel used, the air to fuel-vapor ratio desired, or for conformity with environmental standards.

The ammonia produced at ammonia-producing catalyst 30 may be used to control emissions of NOx from machine 10. In one embodiment, the exhaust from first cylinder group 18 may be supplied to a first exhaust passage 34, and the exhaust from second cylinder group 22 may be supplied to a second exhaust passage 38. At least part of the exhaust from first cylinder group 18 may be converted into ammonia at catalyst 30, and first exhaust passage 34 and second exhaust passage 38 may be merged downstream of catalyst 30, thereby forming a merged exhaust passage 42, configured to receive an ammonia-containing exhaust gas stream from first exhaust passage 38 and a NOx-containing exhaust gas stream from second exhaust passage 38. In addition, the exhaust from first passage 34 may also contain some NOx if all the NOx produced by first cylinder group 18 is not converted into ammonia, or otherwise removed. The ammonia and NOx flowing into merged exhaust passage 42 may react at SCR catalyst 26 to reduce NOx in merged exhaust passage 42.

In some embodiments, it may be desirable to control the amount of NOx or other exhaust gas emissions produced by the cylinders of first cylinder group 18 and second cylinder group 22. For example, in order to provide suitable control of NOx emissions, it may be desirable to control the amount of NOx produced by first and second cylinder groups 18, 22 to produce a certain ratio of ammonia to NOx flowing into SCR catalyst 26. Further, in some embodiments, it may be desirable to control exhaust emissions while maintaining approximately equal power output from each of cylinder 1-6 of engine 12.

The ratio of ammonia and NOx flowing into SCR catalyst 26 may be determined based on a number of factors. For example, generally, the ratio may be selected to maximize NOx reduction while preventing ammonia slip. The desired ratio may be determined based on the overall exhaust gas composition, catalyst temperature, and/or a balance between production of desired machine power outputs and controlling NOx emissions.

The operation of engine 12 may be controlled in a number of suitable ways. For example, machine 12 may include a control unit 46, such as a machine electronic control unit. Control unit 46 may respond to driver demands, current or recent machine operating parameters (e.g. power output, engine speed, load, temperature, exhaust gas concentrations) to control the power output and/or emissions of cylinders 1-6.

Control unit 46 may be configured to control of variety of cylinder operating parameters to effect a desired power output and/or emissions. For example, control unit 46 may control engine parameters such as injection timing, injection pressure, temperature, air-to-fuel ratio, and/or any other suitable parameter. Further, control unit 46 may interface with other machine, engine, and exhaust system components, including for example, gas sensors, pressure sensors, exhaust additive systems, turbochargers, superchargers, air coolers, and/or any other suitable exhaust system or engine component.

In some embodiments, it may be desirable to provide turbocharged or supercharger air to the cylinders of first cylinder group 18 that are operating as two-stroke cylinders. For example, in order to control power output and/or prevent excess smoke production in diesel two-stroke cylinders, a turbocharger 50 or supercharger may be operably connected to cylinders of first cylinder group 18.

In addition, to control the amount of NOx and/or ammonia produced by first cylinder group 18 and ammonia-producing catalyst 30 it may be desirable to control the air-to-fuel ratio within first cylinder group 18 and/or control the exhaust gas composition and/or properties of exhaust flowing into catalyst 30. For example, to increase NOx production by cylinder 1 of first cylinder group 18, it may be desirable to run cylinder 1 with a lean air-to-fuel ratio. However, richer exhaust conditions may favor ammonia production at catalyst 30. Therefore, in some embodiments, a fuel supply device 54 may be provided to supply fuel upstream of catalyst 30. In other embodiments, suitable amounts of NOx and ammonia may be produced by cylinder 1 and catalyst 30 by operating cylinder 1 under stoichiometric or rich conditions, thereby obviating the need for additional enrichment of gases flowing into catalyst 30.

In addition, exhaust system 14 may include a variety of other exhaust system components. For example exhaust system 14 may include any suitable filters, catalysts, and/or sensors to control machine emissions. Such components may include, for example, diesel particulate filters 58, oxidation catalysts 62, or other suitable catalysts 66 (e.g. three-way catalysts). Further these components may be positioned at a variety of suitable exhaust system locations. For example, as shown, a number of components are positioned within merged exhaust passage. Alternatively or additionally, catalysts and/or filters may be positioned within first and/or second exhaust passages 34, 38. For example, one or more catalysts, such as an oxidation catalyst, may be positioned upstream of ammonia-producing catalyst 30 to facilitate production of conditions favorable for ammonia generation.

Exhaust system 14 may further include various coolers and/or exhaust recirculation systems 70. For example, in some embodiments, it may be desirable to cool and/or filter air flowing back into one or more cylinders of engine 12. A variety of suitable air coolers, filters, and exhaust recirculation systems are known in the art. Such systems may improve control of machine emissions and/or fuel efficiency. Further, although not shown, it may be desirable to provide turbocharged air to one or more cylinders of second cylinder group 22 in order to provide increased power output during periods of higher demand.

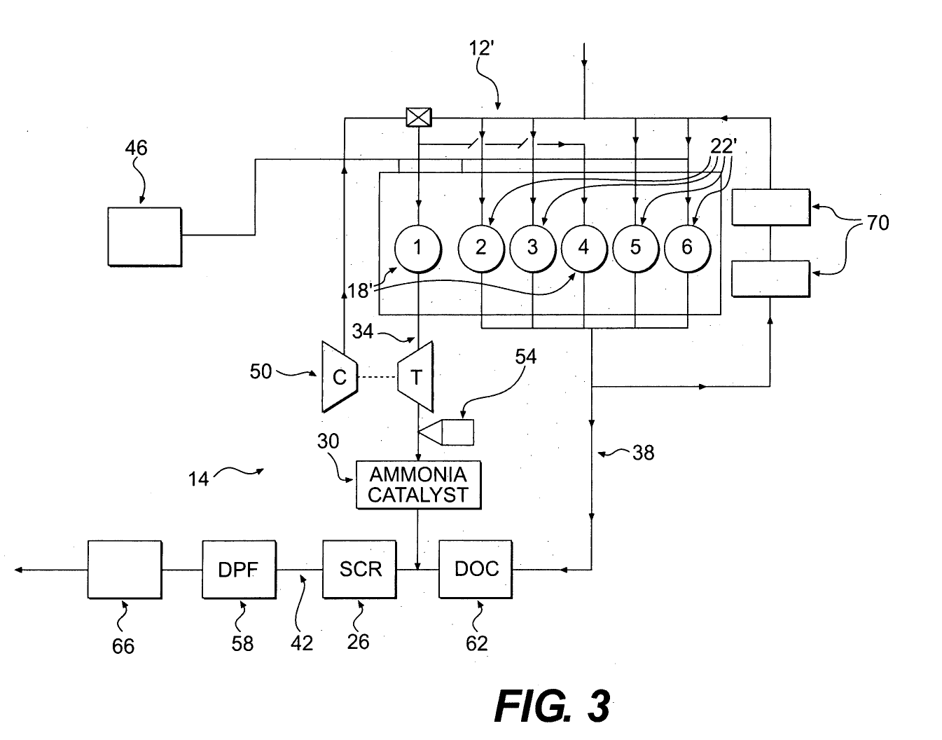

In some embodiments, first cylinder group 18 may include more than one cylinder configured to operate as a two-stroke cylinder. FIG. 3 provides a diagram of an engine 12′ and exhaust system 14 of the present disclosure, according to another exemplary embodiment. In this embodiment, first cylinder group 18′ includes two cylinders 1, 4, which may both be configured to operate in a two-stroke operating mode. Further, second cylinder group 22′ may include two or more cylinders 2, 3, 5, 6 configured to operate in a four-stroke operating mode.

As shown, the cylinders of first cylinder group 18′ may be operably connected with a turbocharger 50 or supercharger to control power output and emissions from cylinders 1, 4.

As in the embodiment of FIG. 2, at least one cylinder of first cylinder group 18′ may be disposed upstream of an ammonia-producing catalyst 30 to facilitate production of ammonia for NOx reduction at a downstream SCR catalyst 26. Further, in other embodiments, both cylinders 1, 4 of first cylinder group 18′ may be configured to provide a NOx-containing exhaust gas stream to ammonia-producing catalyst 30.

It should be noted that although engine 12 is illustrated with six cylinders, including one or two cylinders in a first two-stroke cylinder group 18, 18′ and four or five cylinders in a second four-stroke cylinder group 22, 22′, a range of suitable numbers of cylinders may be selected. For example, engine 12 may include between six and twelve cylinders, and the number of cylinders in first cylinder group 18, 18′ or second cylinder group 22, 22′ may be selected based on a number of factors. For example, the number of cylinders in first and second cylinder group 18, 22 may be selected to allow production of a desired ratio of ammonia and NOx flowing into SCR catalyst 26. Further, the number of cylinders may be selected based on the desired application, desired power output, cost, size constraints, and/or any other suitable factor.

It should be noted that if two or more cylinders are selected for the cylinders of first cylinder group 18′, the cylinders may be selected to provide balanced power strokes along a drive shaft. For example, for a typical in-line six cylinder engine, the firing order of cylinder 1-6, as shown in engine 12′, will by cylinder 1, cylinder, 5, cylinder, 3, cylinder 6, cylinder 2, and then cylinder 4. By selecting cylinder 1 and cylinder 4 as two-stroke cylinders, both cylinders will fire during the first and sixth positions, as compared to a four-stroke engine.

### INDUSTRIAL APPLICABILITY

The present disclosure provides a partial two-stroke engine. The partial two-stroke engine of the present disclosure may be used for any machine where it is beneficial to produce different exhaust gas compositions from one or more cylinders.

The partial two-stroke engine may include a first cylinder group having at least one cylinder configured to operate as a two-stroke cylinder and a second cylinder group configured to operate as a four-stroke cylinder. Further, the power output of each of the cylinders of the engine may be approximately equal, thereby minimizing vibrations.

The engine of the present disclosure may further include an ammonia producing catalyst downstream of the first cylinder group. The ammonia-producing catalyst will allow on-board production of ammonia for control of NOx emissions using selective catalytic reduction. The partial two-stroke engine, having a first two-stroke cylinder group configured to produce NOx for conversion into ammonia and a second four-stroke cylinder group will provide a number of advantages. The power output of each of the cylinders may be balanced to prevent engine vibrations, while still allowing a suitable amount of NOx to be produced for on-board ammonia production. In addition, the two-stroke cylinders of the first-cylinder group will continue to provide adequate power, thereby preventing a need for decreased power output to allow ammonia production. Further, the four-stroke cylinders, which operate more efficiently than two-stroke cylinders, will provide suitable fuel efficiency for on-highway trucks or other applications in which the engine may be used.

It will be apparent to those skilled in the art that various modifications and variations can be made in the disclosed systems and methods without departing from the scope of the disclosure. Other embodiments of the disclosed systems and methods will be apparent to those skilled in the art from consideration of the specification and practice of the embodiments disclosed herein. It is intended that the specification and examples be considered as exemplary only, with a true scope of the disclosure being indicated by the following claims and their equivalents.

What is claimed is:

1. An engine, comprising:
a first cylinder group including at least one cylinder configured to operate in a two-stroke engine operating mode;
a second cylinder group including at least two cylinders configured to operate in a four-stroke engine operating mode, wherein the power outputs of each of the cylinders in the first cylinder group and second cylinder group are approximately equal.

2. The engine of claim 1, wherein the first cylinder group includes one cylinder and the second cylinder group includes five cylinders.

3. The engine of claim 1, wherein the first cylinder group includes two cylinders, and the second cylinder group includes four cylinders.

4. The engine of claim 1, wherein the at least one cylinder of the first cylinder group includes a turbocharged cylinder.

5. The engine of claim 1, wherein the at least one cylinder of the first cylinder group includes a supercharged cylinder.

6. The engine of claim 1, wherein the cylinders of the first cylinder group and the second cylinder group are diesel cylinders.

7. The engine of claim 1, further including a first exhaust passage configured to receive a NOx-containing exhaust gas stream produced by at least one cylinder of the first cylinder group; and
an ammonia-producing catalyst in fluid communication with the first exhaust passage and configured to convert at least a portion of the NOx-containing exhaust gas stream produced by the at least one cylinder of the first cylinder group into ammonia.

8. A method of operating an engine, comprising:
operating a first cylinder group including at least one cylinder in a two-stroke engine operating mode;
operating a second cylinder group including at least two cylinders in a four-stroke engine operating mode, wherein the power outputs of each of the cylinders in the first cylinder group and second cylinder group are approximately equal.

9. The method of claim 8, wherein the first cylinder group includes one cylinder and the second cylinder group includes five cylinders.

10. The method of claim 8, wherein the first cylinder group includes two cylinders, and the second cylinder group includes four cylinders.

11. The method of claim 8, wherein the at least one cylinder of the first cylinder group includes a turbocharged cylinder.

12. The method of claim 8, wherein the at least one cylinder of the first cylinder group includes a supercharged cylinder.

13. The method of claim 8, wherein the cylinders of the first cylinder group and the second cylinder group are diesel cylinders.

14. The method of claim 8, further including
supplying an exhaust gas stream produced by at least one cylinder of the first cylinder group to a first exhaust passage including an ammonia-producing catalyst in fluid communication with the first exhaust passage; and
converting at least a portion of the NOx-containing exhaust gas stream produced by the at least one cylinder of the first cylinder group into ammonia.

15. An engine and exhaust system, comprising:
a first cylinder group including at least one cylinder configured to operate in a two-stroke engine operating mode;
a second cylinder group including at least two cylinders configured to operate in a four-stroke engine operating mode, wherein the power outputs of each of the cylinders in the first cylinder group and second cylinder group are approximately equal;
a first exhaust passage configured to receive a NOx-containing exhaust gas stream produced by at least one cylinder of the first cylinder group;
an ammonia-producing catalyst in fluid communication with the first exhaust passage and configured to convert at least a portion of the NOx-containing exhaust gas stream produced by the at least one cylinder of the first cylinder group into ammonia;
a second exhaust passage configured to receive a NOx-containing exhaust gas stream produced by the second cylinder group;
a merged exhaust passage configured to receive exhaust from the first exhaust passage and second exhaust passage; and
a NOx-reducing catalyst in fluid communication with the merged exhaust passage and configured to facilitate a reaction between ammonia and NOx.

16. The engine and exhaust system of claim 15, wherein the first cylinder group includes one cylinder and the second cylinder group includes five cylinders.

17. The engine and exhaust system of claim 15, wherein the first cylinder group includes two cylinders, and the second cylinder group includes four cylinders.

18. The engine and exhaust system of claim 15, wherein the at least one cylinder of the first cylinder group includes a turbocharged cylinder.

19. The engine and exhaust system of claim 15, wherein the cylinders of the first cylinder group and the second cylinder group are diesel cylinders.

20. The engine and exhaust system of claim 15, further including an engine control unit configured to control the power outputs of each of the cylinders of the first cylinder group and the second cylinder group.
